(19) United States
(12) Patent Application Publication
(10) Pub. No.: US 2005/0231487 A1
(43) Pub. Date: Oct. 20, 2005

(54) Method for manufacturing LCD device with integrated touch panel

(75) Inventor: Jheng Ci Ming, South District (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: Toppoly Optoelectronics Corp., Chu-Nan (TW)

(21) Appl. No.: 11/041,220

(22) Filed: Jan. 25, 2005

(30) Foreign Application Priority Data
Apr. 16, 2004 (TW) 093110781

(51) Int. Cl. G09G 3/36

(52) U.S. Cl. 345/173

(57) ABSTRACT

A driving circuit of a touch panel is formed by the photolithographic process on the liquid crystal display (LCD) panel to reduce the area of the driving circuit. The method includes providing an LCD panel having a common substrate; and forming a touch panel on the common substrate. First, a first conducting layer is formed on the common substrate, and then a second patterned conducting layer is formed on the first conducting layer and on a peripheral region of the LCD panel by a photolithographic process. The common substrate of the LCD panel is used as an upper substrate of the LCD panel and as a lower substrate for the touch panel.

### BACKGROUND OF THE INVENTION

1. Field of the Invention

The invention relates to a method for manufacturing LCD device with integrated touch panel, more particularly to a method for manufacturing LCD device with integrated touch panel to form driving circuit of touch panel onto the LCD panel by photolithographic process.

2. Description of the Prior Art

A touch panel can read the operation of the user by coordinate values and input data. A touch panel is usually installed onto a flat display device such as a thin film transistor (TFT) display device. For example, the Automatic Teller Machines (ATM) with touch panel are located in the bank or along the roadside. When a touch pen or a fingertip presses on the surface of touch panel, a potential signal will be generated in the corresponding point. The information represented from such signal can be processed by other devices.

Please refer to FIG. 1, an LCD device 100 including a LCD panel 110 and a touch panel 120 is shown. The LCD panel 110 includes a lower substrate 112 and an upper substrate 114. A TFT array and a first alignment layer (not shown in the figure) are on the lower substrate 112, and a color filter, a common electrode, and a second alignment layer (not shown in the figure) are on the upper substrate 114. The lower substrate 112 is called as a TFT substrate and the upper substrate 114 is called as a color filter substrate. Liquid crystal (not shown in the figure) is filled to the gap that is formed by spacers (not shown in the figure) between the lower substrate 112 and the upper substrate 114. A first polarizer 116 is below the lower substrate 112 and a second polarizer 118 is on the upper substrate 114. The touch panel 120 is adhered onto the LCD panel 110 by the double-coated tapes.

However, the volume and weight of the touch panel 120 increases the entire volume and weight of the LCD device 100. Also, the transmittance and brightness of the integral LCD device 100 is reduced since the touch panel 120 is adhered to the LCD panel 110 by double-coated tape.

Further, the driving circuit of a touch panel is generally located on four rims of the touch panel, and touched area is put in the center of such panel. Today, the driving circuit of touch panel is produced by a screen print method. Due to the poor accuracy of the screen printing method, the area of such driving circuit becomes larger. Besides, when a complicated driving circuit, such as near field image (NFI) type or capacitive type, of a touch panel is required, the driving circuit formed by screen printing becomes even larger. Thus, when the driving circuit is formed by screen printing, it is impractical to install the near field image (NFI) or capacitive type touch panel onto a small/medium size LCD device.

### SUMMARY OF THE INVENTION

In the light of the state of the art described above, it is an object of the present invention to provide a method for manufacturing LCD device with integrated touch panel to form driving circuit of touch panel onto the LCD panel by photolithographic process, which are immune to the problems described above.

It is another object of this invention to decrease the area of driving circuit of touch panel. Thus, a near field image (NFI) type or a capacitive type touch panel can be installed onto a small/medium size LCD device.

It is a further object of this invention to decrease the whole volume and weight of the LCD device with touch panel. An LCD panel having a common substrate is provided. Then, a touch panel is formed on the common substrate. Specifically, a first conducting layer is formed on the common substrate, and a second patterned conducting layer is formed on the first conducting layer and on a peripheral region of the LCD panel by a photolithographic process.

According to an embodiment of the present invention, the second patterned conducting layer is formed by the following steps. A second conducting layer is formed on the first conducting layer. Then, a photoresist layer is formed on the second conducting layer. The photoresist layer is irradiated and developed through a photomask with a pattern of a driving circuit to form a patterned photoresist layer. Then, the second conducting layer is etched using the patterned photoresist layer to form the second patterned conducting layer. Then, the patterned photoresist layer is removed.

The present invention provides a liquid crystal display (LCD) device with integrated touch panel. The LCD device includes an LCD panel having a common substrate; and a touch panel on the common substrate. The touch panel includes a first conducting layer on the common substrate, and a second patterned conducting layer panel on a peripheral region of the LCD panel.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 schematically illustrates the cross-sectional view of a conventional LCD device with touch panel;

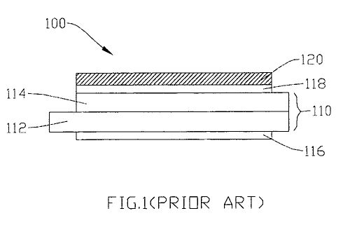

FIG. 2 schematically illustrates the cross-sectional view of an LCD device with integrated touch panel according to an embodiment of the present invention;

FIGS. 3A to 3C are cross-section illustrating the process flow of forming the first and second conducting layers of the touch panel according to an embodiment of the present invention.

### DESCRIPTION OF THE PREFERRED EMBODIMENT

Some sample embodiments of the present invention will now be described in greater detail. Nevertheless, it should be recognized that the present invention can be practiced in a wide range of other embodiments besides those explicitly described, and the scope of the present invention is expressly not limited except as specified in the accompanying claims.

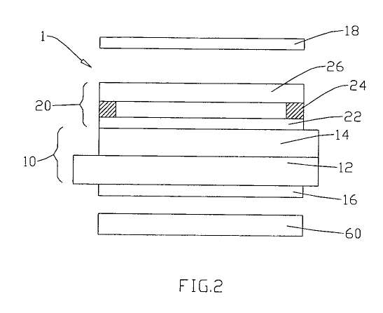

FIG. 2 shows a cross-sectional view of a liquid crystal display (LCD) device 1 with an integrated touch panel according to an embodiment of the present invention is shown. The LCD device 1 includes an LCD panel 10, a touch panel 20, a first polarizer 16, a second polarizer 18, and a light source 60. The first polarizer 16 is located between the LCD panel 10 and the light source 60, and the second polarizer 18 is located on the touch panel 20. The LCD panel 10 has a lower substrate 12 and a common substrate 14. A TFT array (not shown in the figure) is on the lower substrate 12 for controlling the direction of liquid crystal, and a color filter (not shown in the figure) is on the common substrate 14. Liquid crystal (not shown in the figure) is filled to a gap between the lower substrate 12 and the common substrate 14.

Still referring to FIG. 2, the touch panel 20 includes a first conducting layer 22, a second conducting layer 24, and an upper substrate 26. The common substrate 14 of the LCD panel 10 is disposed below the first conducting layer 22. The common substrate 14 is used as the upper substrate of the LCD panel 10 and as the lower substrate for the touch panel 20. The touch panel 20 can be a glass to glass type, a film to glass type or a film to film type. If the touch panel 20 is a glass to glass type or a film to glass type, the common substrate 14 of the LCD panel 10 is glass. If the touch panel 20 is a film to film type, the common substrate 14 of the LCD panel 10 is film. The touch panel 20 can be a near field image (NFI) type or a capacitive type.

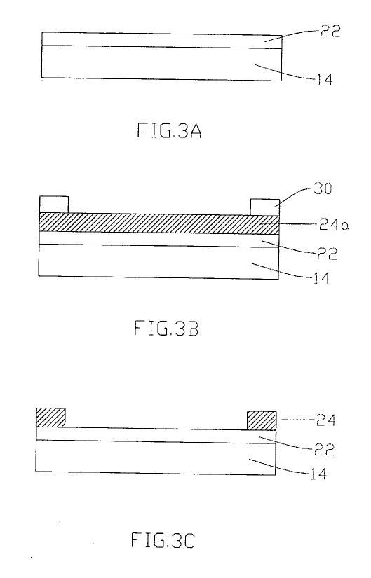

FIGS. 3A to 3C are cross-section illustrating the process flow of forming the first and second conducting layers of the touch panel. First, a first conducting layer 22 is formed on the common substrate 14 of the LCD panel, as shown in FIG. 3A. The method of forming the first conducting layer 22 can be a conventional sputtering method. Then, referring to FIG. 3B, a second conducting layer 24a is formed on the first conducting layer 22. The material of the second conducting layer 24a can be any material with low resistance and high conductance, not limited to be transparent electrode, deposited by the physical vapor deposition (PVD) method, the chemical vapor deposition (CVD) method, or attached directly by the double-coated conducting tape.

Still referring to FIG. 3B, next, a photoresist layer (not shown) is formed on the second conducting layer 24a by the spin-coating method. The material of the photoresist layer is a photosensitive material. We can use the positive or negative photoresist in this invention. Then, the photoresist layer is irradiated through a photomask (not shown) with the pattern of a driving circuit. After development, the remaining photoresist layer 30 is shown in FIG. 3B.

Then, the second conducting layer 24a is etched, either by wet or dry etching, by using the remaining photoresist 30 as the mask, forming a patterned second conducting layer 24. For example, a reactive ion etch (RIE) process can be used. After the remaining photoresist layer 30 is removed, the second conducting layer 24 as the driving circuit of the touch panel 20 is formed, as shown in FIG. 3C. The remaining photoresist 30 is in the peripheral region of the LCD panel 10 and in the shape of the driving circuit. Thus, the patterned second conducting layer 24 is in the peripheral region of the LCD panel 10 and serves as the driving circuit.

As mentioned above, the second conducting layer 24 is formed by the photolithographic process. The photolithographic process has higher accuracy than the conventional screen printing process. Thus, by means of the photolithographic process, the driving circuit (the second conducting layer 24) of the touch panel 20 can be made to have a smaller area. Furthermore, a complicated driving circuit for the near field image (NFI) type or capacitive type, which requires a larger circuit area, can also be made to have a smaller area. Thus, according to the present invention, since the driving circuit (the second conducting layer 24) of the touch panel 20 is formed by the photolithographic process, it is possible to install the near field image (NFI) or capacitive type touch panel onto a small/medium size LCD device. Furthermore, since the common substrate 14 is commonly owned by the LCD panel and the touch panel, that is, the common substrate 14 is used as the upper substrate of the LCD panel and as the lower substrate for the touch panel, the whole volume and weight of the integral LCD device with touch panel can be slim and light. Also, the aperture ratio, transmittance, and brightness of the integral LCD device is increased.

Although the specific embodiment has been illustrated and described, it will be obvious to those skilled in the art that various modifications may be made without departing from what is intended to be limited solely by the appended claims.

1. A method for manufacturing liquid crystal display (LCD) device with integrated touch panel, including the steps of:
providing an LCD panel having a common substrate and a peripheral region; and
forming a touch panel on the common substrate, wherein the step of forming the touch panel comprises forming a first conducting layer on the common substrate, and forming a second patterned conducting layer on the first conducting layer and on the peripheral region of the LCD panel by a photolithographic process.

2. The method according to claim 1, wherein the step of forming the second patterned conducting layer comprises the steps of:
forming a second conducting layer on the first conducting layer;
forming a photoresist layer on the second conducting layer;
irradiating and developing the photoresist layer through a photomask with a pattern of a driving circuit to form a patterned photoresist layer;
etching the second conducting layer using the patterned photoresist layer to form the second patterned conducting layer; and
removing the patterned photoresist layer.

3. The method according to claim 1, wherein the second patterned layer is used as a driving circuit of the touch panel.

4. The method according to claim 1, wherein said touch panel is a near field image (NFI) type.

5. The method according to claim 1, wherein said touch panel is a capacitive type.

6. A liquid crystal display (LCD) device with integrated touch panel, comprising:
an LCD panel having a common substrate and a peripheral region; and
a touch panel on the common substrate, wherein the touch panel comprises a first conducting layer on the common substrate, and a second patterned conducting layer panel on the peripheral region of the LCD panel.

7. The LCD device according to claim 6, wherein the second patterned conducting layer is used as a driving circuit of the touch panel.

8. The LCD device according to claim 6, wherein the touch panel further comprises an upper substrate on the second patterned conducting layer.

9. The LCD device according to claim 6, further comprising a polarizer on the upper substrate of the touch panel.

10. The LCD device according to claim 6, wherein said touch panel is a near field image (NFI) type.

11. The LCD device according to claim 6, wherein said touch panel is a capacitive type.
